(19) United States
(12) Patent Application Publication
(10) Pub. No.: US 2025/0080147 A1
(43) Pub. Date: Mar. 6, 2025

(54) RADIOWAVE INFORMATION OUTPUT DEVICE, RADIOWAVE INFORMATION OUTPUT METHOD, AND RECORDING MEDIUM

(71) Applicant: NEC Corporation, Minato-ku, Tokyo (JP)

(72) Inventors: Takashi Kuribara, Tokyo (JP); Kohei Sugai, Tokyo (JP); Masato Kita, Tokyo (JP); Ryosuke Kumagai, Tokyo (JP)

(73) Assignee: NEC Corporation, Minato-ku, Tokyo (JP)

(21) Appl. No.: 18/729,660

(22) PCT Filed: Feb. 16, 2022
(86) PCT No.: PCT/JP2022/006226

§ 371 Date: Jul. 17, 2024

(51) Int. Cl. H04B 1/10; H04B 1/12; H04B 17/345

(52) U.S. Cl. CPC H04B 1/1027; H04B 1/12; H04B 17/345

(57) ABSTRACT

A radiowave information output device receives reception waveform data and radiowave information for a reception radiowave being a radiowave received by a radiowave sensor, executes collation in such a way as to determine whether reception meta data being information included in the received radiowave information and identification information relating to a transmission source of a radiowave match with collation meta data being identification information relating to a transmission source of a known radiowave, executes collation for the reception radiowave whose reception meta data do not match with any piece of the collation meta data in such a way as to determine whether a reception signal waveform matches with a collation signal waveform being a signal waveform of the known radiowave, and outputs unknown radiowave information for an unknown radiowave being the reception radiowave whose reception signal waveform does not match with any of the collation signal waveforms.

### TECHNICAL FIELD

The present invention relates to a radiowave information output device and the like.

### BACKGROUND ART

In wireless communication, one of factors that reduce throughput is radiowave interference.

When radiowave interference occurs, and throughput is reduced, quality of services to be provided via wireless communication may be degraded. Examples of degradation of service quality include disruptions in a video or audio being reproduced, degradation of control accuracy for remote control, and the like.

Thus, when radiowave interference occurs, it is desired that a measure against radiowave interference be taken for resolving the radiowave interference.

However, reduction in throughput may be caused by a factor other than radiowave interference. Thus, when a measure against radiowave interference is taken, investigation on whether radiowave interference occurs is first required.

In general, reduction in throughput is detected when degradation of service quality occurs. Further, in general, an investigator visits a site where the degradation of service quality occurs, and the investigator conducts investigation on whether radiowave interference occurs, by checking a radio status and the like in the periphery. Further, when radiowave interference occurs, an interference source is specified, and a measure against radiowave interference is taken.

Further, the related-art techniques include techniques described in PTL 1 and PTL 2.

### CITATION LIST

### Patent Literature

PTL 1: Japanese Unexamined Patent Application Publication No. 2010-127833
PTL 2: Japanese Unexamined Patent Application Publication No. 2020-161065

### SUMMARY OF INVENTION

### Technical Problem

However, a general method for investigating radiowave interference as described above requires an investigator on sight, and thus requires time and labor.

As a method for reducing such time and labor, there is conceived a method in which a large number of sensors installed in a field acquire radiowave information, a management device collects the radiowave information from the sensors, and a user investigates radiowave interference, based on the information being collected.

However, a large number of radiowave transmission sources are present in the field. Thus, when all pieces of information being collected from the sensors are provided to a user, an excessive amount of information is provided to the user, which causes information overload for the user. As a result, it takes a significant amount of time for investigating radiowave interference or specifying an interference source. Consequently, investigation of radiowave interference and specification of an interference source require a large amount of time and labor.

In view of the above-mentioned problem, an object of the present invention is to provide a radiowave information output device and the like capable of outputting information for reducing time and labor for investigating radiowave interference and specifying an interference source.

### Solution to Problem

According to one aspect of the present invention, a radiowave information output device includes: a reception means for receiving reception waveform data and radiowave information for a reception radiowave being a radiowave received by a radiowave sensor, the reception waveform data being data indicating a signal waveform of the reception radiowave: a collation means for executing collation in such a way as to determine whether reception meta data being information included in the received radiowave information and identification information relating to a transmission source of a radiowave match with collation meta data being identification information relating to a transmission source of a known radiowave, and executing collation for the reception radiowave whose reception meta data do not match with any piece of the collation meta data in such a way as to determine whether a reception signal waveform being a signal waveform indicated by the reception waveform data matches with a collation signal waveform being a signal waveform of the known radiowave; and an output means for outputting unknown radiowave information for an unknown radiowave being the reception radiowave whose reception signal waveform does not match with any of the collation signal waveforms, unknown radiowave information being information relating to the unknown radiowave.

Further, according to another aspect of the present invention, a radiowave information output method includes: receiving reception waveform data and radiowave information for a reception radiowave being a radiowave received by a radiowave sensor, the reception waveform data being data indicating a signal waveform of the reception radiowave; executing collation in such a way as to determine whether reception meta data being information included in the received radiowave information and identification information relating to a transmission source of a radiowave match with collation meta data being identification information relating to a transmission source of a known radiowave, and executing collation for the reception radiowave whose reception meta data do not match with any piece of the collation meta data in such a way as to determine whether a reception signal waveform being a signal waveform being indicated by the reception waveform data matches with a collation signal waveform being a signal waveform of the known radiowave; and outputting unknown radiowave information for an unknown radiowave being the reception radiowave whose reception signal waveform does not match with any of the collation signal waveforms, unknown radiowave information being information relating to the unknown radiowave.

Further, according to still another aspect of the present invention, a radiowave information output program recorded in a computer-readable recording medium causes a computer to achieve: a reception function of receiving reception waveform data and radiowave information for a reception radiowave being a radiowave received by a radiowave sensor, the reception waveform data being data indicating a signal waveform of the reception radiowave; a collation function of executing collation in such a way as to determine whether reception meta data being information included in the received radiowave information and identification information relating to a transmission source of a radiowave match with collation meta data being identification information relating to a transmission source of a known radiowave, and executing collation for the reception radiowave whose reception meta data do not match with any piece of the collation meta data in such a way as to determine whether a reception signal waveform being a signal waveform being indicated by the reception waveform data matches with a collation signal waveform being a signal waveform of the known radiowave; and an output function of outputting unknown radiowave information for an unknown radiowave being the reception radiowave whose reception signal waveform does not match with any of the collation signal waveforms, unknown radiowave information being information relating to the unknown radiowave.

Further, according to still another aspect of the present invention, a radiowave information output system includes: a reception means for receiving reception waveform data and radiowave information for a reception radiowave being a radiowave received by a radiowave sensor, the reception waveform data being data indicating a signal waveform of the reception radiowave: a collation means for executing collation in such a way as to determine whether reception meta data being information included in the received radiowave information and identification information relating to a transmission source of a radiowave match with collation meta data being identification information relating to a transmission source of a known radiowave, and executing collation for the reception radiowave whose reception meta data do not match with any piece of the collation meta data in such a way as to determine whether a reception signal waveform being a signal waveform being indicated by the reception waveform data matches with a collation signal waveform being a signal waveform of the known radiowave; and an output means for outputting unknown radiowave information for an unknown radiowave being the reception radiowave whose reception signal waveform does not match with any of the collation signal waveforms, unknown radiowave information being information relating to the unknown radiowave.

### Advantageous Effects of Invention

According to the present invention, it is possible to output information for reducing time and labor for investigating radiowave interference and specifying an interference source.

### BRIEF DESCRIPTION OF DRAWINGS

FIG. 1 is a diagram illustrating a configuration example of a radiowave information output device according to a first example embodiment of the present invention.

FIG. 2 is a diagram illustrating an example of an operation flow of the radiowave information output device according to the first example embodiment of the present invention.

FIG. 3 is a diagram illustrating a configuration example of a system including a radiowave information output device of a second example embodiment according to the present invention.

FIG. 4 is a diagram illustrating a configuration example of the radiowave information output device according to the second example embodiment of the present invention.

FIG. 5 is a diagram illustrating another configuration example of a system including the radiowave information output device according to the second example embodiment of the present invention.

FIG. 6 is a diagram illustrating a configuration example of a learning device according to the second example embodiment of the present invention.

FIG. 7 is a diagram illustrating an example of an image that the radiowave information output device according to the second example embodiment of the present invention causes a display device to display.

FIG. 8 is a diagram illustrating an example of an operation flow of the radiowave information output device according to the first example embodiment of the present invention.

FIG. 9 is a diagram illustrating an example of an operation flow of the learning device according to the second example embodiment of the present invention.

FIG. 10 is a diagram illustrating an example of an operation flow of the learning device according to the second example embodiment of the present invention.

FIG. 11 is a diagram illustrating a hardware configuration example of each of the example embodiments of the present invention.

### EXAMPLE EMBODIMENT

### First Example Embodiment

A first example embodiment of the present invention is described.

One specific example of a radiowave information output device 10 of the first example embodiment is a radiowave information output device 20 of a second example embodiment, which is described later.

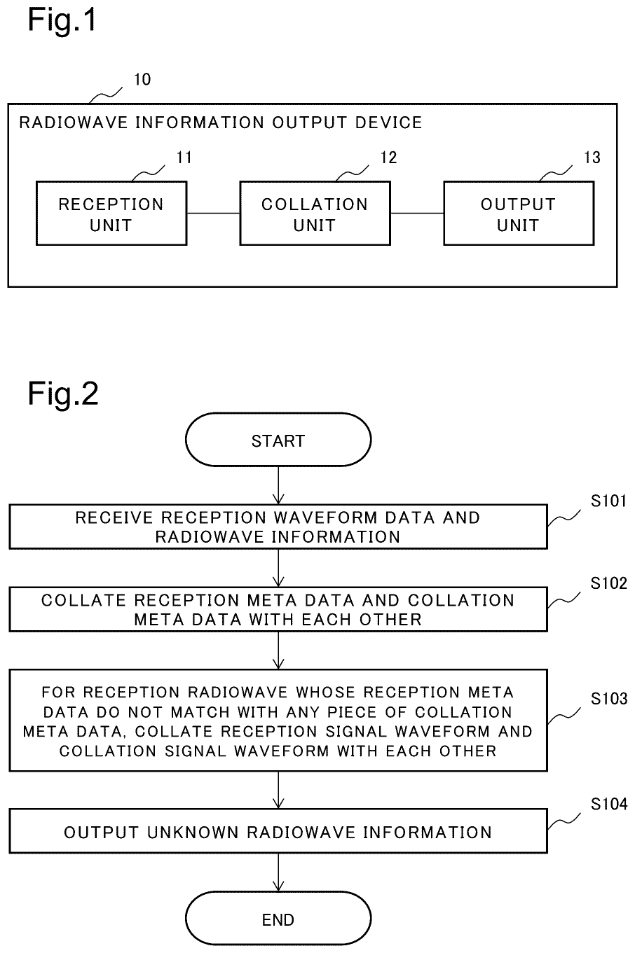

First, a configuration example of the radiowave information output device 10 according to the present example embodiment described. FIG. 1 illustrates the configuration example of the radiowave information output device 10 according to the present example embodiment. The radiowave information output device 10 includes a reception unit 11, a collation unit 12, and an output unit 13.

The reception unit 11 receives reception waveform data and radiowave information for a reception radiowave. The reception radiowave is a radiowave received by a radiowave sensor. The reception waveform data is data indicating a signal waveform of the reception radiowave. The radiowave information is information relating to the radiowave. The radiowave information includes identification information relating to a transmission source of the radiowave.

The collation unit 12 executes collation in such a way as to determine whether reception meta data matches with collation meta data. The reception meta data is information included in the received radiowave information and the identification information relating to the transmission source of the radiowave. The collation meta data is identification information relating to a transmission source of a known radiowave.

Further, the collation unit 12 executes collation for the reception radiowave whose reception meta data does not match with any piece of the collation meta data in such a way as to determine whether reception signal waveform matches with collation signal waveform. The reception signal waveform is a signal waveform being indicated by the reception waveform data. The collation signal waveform is a signal waveform of the known radiowave.

The output unit 13 outputs the unknown radiowave information. The unknown radiowave information is information relating to an unknown radiowave. The unknown radiowave is the reception radiowave whose reception signal waveform does not match with any collation signal waveform.

Next, an example of an operation flow of the radiowave information output device 10 according to the present example embodiment is described. FIG. 2 illustrates an example of the operation flow of the radiowave information output device 10 according to the present example embodiment.

The reception unit 11 receives the reception waveform data and the radiowave information for the reception radiowave (step S101). The reception radiowave is a radiowave received by the radiowave sensor. The reception waveform data is data indicating the signal waveform of the reception radiowave. The radiowave information includes the identification information relating to the transmission source of the radiowave.

The collation unit 12 executes collation in such a way as to determine whether the reception meta data matches with the collation meta data (step S102). The reception meta data is information included in the received radiowave information and the identification information relating to the transmission source of the radiowave. The collation meta data is the identification information relating to the transmission source of the known radiowave.

Further, the collation unit 12 executes collation for the reception radiowave whose reception meta data does not match with any piece of the collation meta data in such a way as to determine whether the reception signal waveform matches with the collation signal waveform (step S103). The reception signal waveform is a signal waveform being indicated by the reception waveform data. The collation signal waveform is a signal waveform of the known radiowave.

The output unit 13 outputs the unknown radiowave information (step S104). The unknown radiowave information is information relating to the unknown radiowave. The unknown radiowave is the reception radiowave whose reception signal waveform does not match with any collation signal waveform.

As described above, in the first example embodiment of the present invention, the radiowave information output device 10 includes the reception unit 11, the collation unit 12, and the output unit 13. The reception unit 11 receives the reception waveform data and the radiowave information for the reception radiowave. The reception radiowave is a radiowave received by the radiowave sensor. The reception waveform data is data indicating the signal waveform of the reception radiowave. The radiowave information includes the identification information relating to the transmission source of the radiowave. The collation unit 12 executes collation in such a way as to determine whether the reception meta data matches with the collation meta data. The reception meta data is information included in the received radiowave information and the identification information relating to the transmission source of the radiowave. The collation meta data is the identification information relating to the transmission source of the known radiowave. Further, the collation unit 12 executes collation for the reception radiowave whose reception meta data does not match with any piece of the collation meta data in such a way as to determine whether the reception signal waveform matches with the collation signal waveform. The reception signal waveform is a signal waveform being indicated by the reception waveform data. The collation signal waveform is a signal waveform of the known radiowave. The output unit 13 outputs the unknown radiowave information. The unknown radiowave information is information relating to the unknown radiowave. The unknown radiowave is the reception radiowave whose reception signal waveform does not match with any collation signal waveform.

In this manner, the radiowave information output device 10 outputs information relating to the unknown radiowave. The radiowave information output device 10 outputs the information relating to the unknown radiowave, and thus an investigator can refer to the information being output, determine possibility of occurrence of radiowave interference more easily, and take a measure against radiowave interference. As a result, time and labor for investigating radiowave interference and specifying an interference source can be reduced. Thus, it is possible to output information for reducing time and labor for investigating radiowave interference and specifying an interference source.

### Second Example Embodiment

Next, the radiowave information output device 20 according to the second example embodiment of the present invention is described. One specific example of the radiowave information output device 10 of the first example embodiment is the radiowave information output device 20 of the second example embodiment.

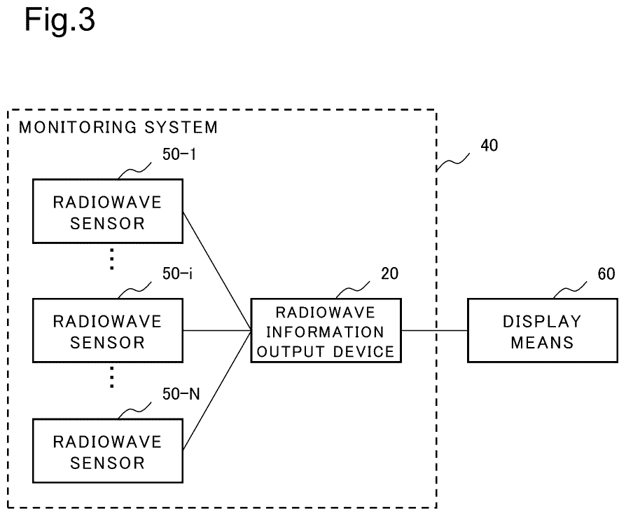

First, FIG. 3 illustrates a configuration example of a system including the radiowave information output device 20 according to the present example embodiment. The radiowave information output device 20 is mutually connected to a radiowave sensor 50-i (i is an integer equal to one or more and equal to or less than N). Further, the radiowave information output device 20 is mutually connected to a display means 60. The radiowave sensor 50-i and the radiowave information output device 20 are included in a monitoring system 40.

The radiowave sensor 50-i receives a radiowave. Hereinafter, the radiowave received by the radiowave sensor 50-i is referred to as a reception radiowave. Further, the radiowave sensor 50-i outputs, to the radiowave information output device 20, the reception waveform data and the radiowave information for the reception radiowave. The reception waveform data is data indicating the signal waveform of the reception radiowave. The radiowave information is information relating to the radiowave. The radiowave information includes the identification information relating to the transmission source of the radiowave.

The radiowave sensor 50-i may be installed in a fixed manner, or may be movable. Further, a communication method for outputting the reception waveform data and the radiowave information from the radiowave sensor 50-i to the radiowave information output device 20 may be a wired method or a wireless method.

The display means 60 is a machine interface such as a display functioning as an output device. The display means 60 displays an image. In the present example embodiment, it is assumed that the radiowave information output device 20 outputs the unknown radiowave information being information relating to the radiowave information to the display means 60. However, an output destination of the unknown radiowave information may be freely selected. The radiowave information output device 20 may output the unknown radiowave information to an output destination other than the display means 60.

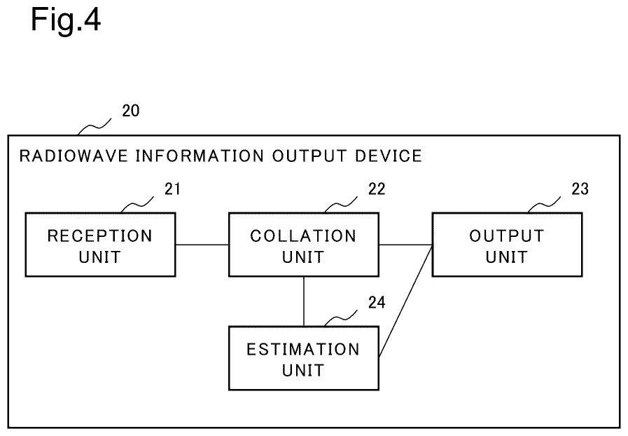

Next, FIG. 4 illustrates a configuration example of the radiowave information output device 20 according to the present example embodiment. The radiowave information output device 20 according to the present example embodiment includes a reception unit 21, a collation unit 22, an output unit 23, and an estimation unit 24.

The reception unit 21 receives the reception waveform data and the radiowave information from the radiowave sensor 50-i. The reception waveform data is data indicating the signal waveform of the reception radiowave. The reception radiowave is a radiowave received by the radiowave sensor 50-i. The radiowave information is information relating to the radiowave. The radiowave information includes the identification information relating to the transmission source of the radiowave. Hereinafter, the identification information relating to the transmission source of the radiowave is referred to as radiowave identification information. Further, hereinafter, the radiowave identification information included in the radiowave information received by the reception unit 21 is referred to as reception meta data.

The radiowave identification information is information that enables identification of an individual transmission source. For example, the radiowave identification information may include international mobile equipment identity (IMEI), international mobile subscriber identity (IMSI), a media access control (MAC) address, or the like. When the transmission source is a drone, the radiowave identification information may include a remote identification (ID) being identification information relating to the drone.

Further, when the transmission source is a base station, the radiowave identification information may include a physical cell identifier (PCI). Further, the radiowave identification information may include a number for an area of beamforming, which is included in a synchronization signal (SS) block (SSB)/a physical broadcast channel (PBCH) block. The PCI or the number for the area of beamforming alone cannot specify an individual transmission source, but can narrow down individual bodies being associated therewith in combination with another piece of information. For example, when the radiowave identification information includes the PCI and the number for the area of beamforming, the transmission source being associated therewith is specified substantially uniquely.

Further, the radiowave identification information may include information based on position information relating to the transmission source. For example, when the transmission source is installed in a fixed manner, the position information relating to the transmission source may be used as the radiowave identification information. Further, when the transmission source moves in the same route, the movement route of the transmission source may be used as the radiowave identification information.

The radiowave sensor 50-i can acquire the position information relating to the transmission source, from a radiowave being transmitted from the transmission source. For example, the transmission source acquires the position of the own transmission source by using the global navigation satellite system (GNSS). Further, the radiowave sensor 50-i can acquire the position information relating to the transmission source, from the signal including the position information, by monitoring the signal being transmitted from the transmission source.

Further, the radiowave identification information may include information relating to a frequency of the radiowave. For example, the radiowave identification information may include information such as a synchronization signal (SS) reference. A large number of transmission sources that use the same frequency are present, but a combination of frequency information and another piece of information, for example, position information may possibly narrow down candidates for an individual transmission source.

Further, in addition to the radiowave identification information, the radiowave information may include information relating to the radiowave being transmitted from the transmission source, such as a frequency, a modulation method, and a reception signal level at the radiowave sensor 50-i. For example, the radiowave information may include information such as synchronization signal reference signal received quality (SS-RSRQ).

Further, the radiowave information may include position specification information being information that can be used for specifying a position of the transmission source. For example, the position specification information may include direction information indicating an arrival direction of the radiowave. For example, the radiowave sensor 50-i can estimate an arrival direction of a signal by an antenna capable of controlling directivity by beamforming or rotation. Further, the position specification information may include information to be used in a radiowave transmission position estimation method such as an angle-of-arrival (AOA) method, a power-of-arrival (POA) method, and a time-difference-of-arrival (TDOA) method.

The collation unit 22 executes collation in such a way as to determine whether the reception meta data and the collation meta data match with each other. The reception meta data is the radiowave identification information included in the radiowave information received by the reception unit 21. The collation meta data is radiowave identification information relating to a radiowave being output from a known transmission source. The known transmission source is a wireless base station that is legitimately installed, a legitimate wireless terminal, or the like. The collation meta data is stored in a storage unit (omitted in illustration). The storage unit may be provided inside or outside of the radiowave information output device 20.

When the radiowave identification information includes two or more types of meta data, the collation unit 22 determines whether the reception meta data and the collation meta data matches with each other, according to a predetermined collation condition. The collation condition is a condition that is satisfied when the collation unit 22 determines that the reception meta data and the collation meta data match with each other for the meta data being used as the radiowave identification information. The collation condition is set to a freely selected condition according to the meta data being used as the radiowave identification information.

For example, the collation condition may be satisfied when any one of a first condition and a second condition is satisfied. For example, the first condition is satisfied when any piece of meta data that can uniquely specify an individual body by itself, such as IMEI, matches. For example, the second condition may be satisfied when all pieces of meta data, which cannot uniquely specify an individual body by themselves and are included in a predetermined meta data combination, match. For example, the second condition may be satisfied when both the PCI and the number for the area of beamforming match.

Further, the collation unit 22 executes collation for the reception radiowave whose reception meta data does not match with any piece of the collation meta data in such a way as to determine whether the reception signal waveform matches with the collation signal waveform. The reception signal waveform is a signal waveform being indicated by the reception waveform data. The collation signal waveform is a signal waveform of the known radiowave. A specific method of collating the reception signal waveform and the collation signal waveform with each other is described later.

The output unit 23 outputs the unknown radiowave information. The unknown radiowave information is information relating to the reception radiowave whose reception signal waveform does not match with any collation signal waveform. The reception radiowave whose reception signal waveform does not match with any collation signal waveform is a reception radiowave for which there is no match as a result of collation with known radiowave identification information and collation with known signal waveform. In other words, information relating to an unknown reception radiowave is output as the unknown radiowave information. Hereinafter, the reception radiowave whose reception signal waveform does not match with any collation signal waveform is referred to as an unknown radiowave in some cases. The unknown radiowave is a radiowave that is transmitted from an illegitimate transmission source such as an illegitimate base station and an illegitimate terminal and a radiowave that is abnormal due to some malfunction even when the radiowave is transmitted from a legitimate transmission source.

In this manner, in the present example embodiment, the output unit 23 outputs the information relating to the unknown radiowave as the unknown radiowave information. Thus, a user provided with the information can easily grasp presence of a radiowave transmitted from an illegitimate transmission source or an abnormal radiowave. As a result, a measure against an unknown radiowave is facilitated.

The output unit 23 may prevent an output of information relating to a known reception radiowave. When an output of the information relating to the known reception radiowave is prevented, an information amount from the radiowave information output device 20 to an output destination can be reduced, and a communication load can be reduced. Further, it becomes easier for a user to select and prioritize information.

Further, the output unit 23 may output known radiowave information being information relating to the known reception radiowave (also referred to as a known radiowave), distinctively from the unknown radiowave information. The known reception radiowave is the reception radiowave whose reception meta data matches with any piece of the collation meta data or the reception radiowave whose reception signal waveform matches with any collation signal waveform.

In the present example embodiment, the output unit 23 outputs the unknown radiowave information to the display means 60. Further, in the present example embodiment, the unknown radiowave information is image information for causing the display means 60 to display the image. In other words, the output unit 23 outputs the unknown radiowave information to the display means 60, and thus the display means 60 is caused to display the image.

Further, the estimation unit 24 specifies a position of a transmission source of an unknown radiowave. A method of estimating a position is described later. The unknown radiowave information being output from the output unit 23 may include information relating to the position of the transmission source of the unknown radiowave, which is estimated by the estimation unit 24.

Next, collation between the reception signal waveform and the collation signal waveform is described more specifically. The collation unit 22 according to the present example embodiment executes collation between the signal waveforms, in addition to collation between the radiowave identification information pieces. With this, collation can be executed for a radiowave whose radiowave identification information is not included in the radiowave or a radiowave whose radiowave identification information cannot be acquired at the radiowave sensor 50-i. Further, the reception radiowave whose information is included in the unknown radiowave information can further be narrowed down.

For example, the collation unit 22 executes collation in such a way as to determine whether the reception signal waveform matches with the collation signal waveform, based on radiowave feature information. The radiowave feature information is information indicating a feature of a signal waveform of a radiowave, which differs for each transmission source transmitting a radiowave.

A device that transmits a radiowave is manufactured to comply with a predetermined communication standard, but has a slight individual difference due to a variation in an analog circuit or the like. Therefore, a radiowave has a feature value that can be identified based on an individual difference of a device being a transmission source. For example, the radiowave feature information is a feature value based on a modulation error acquired by a modulation analysis, a feature value based on a time waveform of a radiowave, or the like. Further, for example, the radiowave feature information may be, but not limited to, a feature value indicating one or more of transient characteristics of a reception signal (rise and fall times), power spectral density of a preamble part, error vector magnitude (EVM), an IQ phase error, IQ imbalance, a frequency offset, and a symbol clock error.

The feature values described above may differ due to a usage environment or a reception environment even when the feature values are in radiowaves transmitted from the same device. Therefore, whether the collation signal waveform matches with the reception signal waveform may not always be determined based on complete matching therebetween, and it may be considered as a match when a similarity degree therebetween is equal to or greater than a predetermined threshold value, for example.

Next, a method of collation between the reception signal waveform and the collation signal waveform is described. For example, the collation unit 22 executes collation in such a way as to determine whether the reception signal waveform matches with the collation signal waveform by collating the radiowave feature information being extracted from the reception waveform data and collation information with each other. The collation information is stored in the storage unit. In this case, the collation information is the radiowave feature information relating to the collation signal waveform.

First, the collation unit 22 extracts the radiowave feature information from the reception waveform data received by the reception unit 21. An extraction rule indicating which feature value to be extracted as the radiowave feature information from the reception waveform data is determined in advance. The collation unit 22 extracts the radiowave feature information from the reception waveform data, according to the extraction rule.

Further, the collation unit 22 collates the radiowave feature information being extracted from the reception waveform data and the collation information with each other. More specifically, the collation unit 22 executes collation in such a way as to determine whether the radiowave feature information being extracted from the reception waveform data includes the radiowave feature information whose similarity degree with the collation information is equal to or greater than the predetermined value. Various methods can be used as a method of calculating the similarity degree. Further, in this case, the collation information is radiowave feature information being extracted from signal waveform data relating to the radiowave being output from the known transmission source. Further, the collation information is stored in the storage unit.

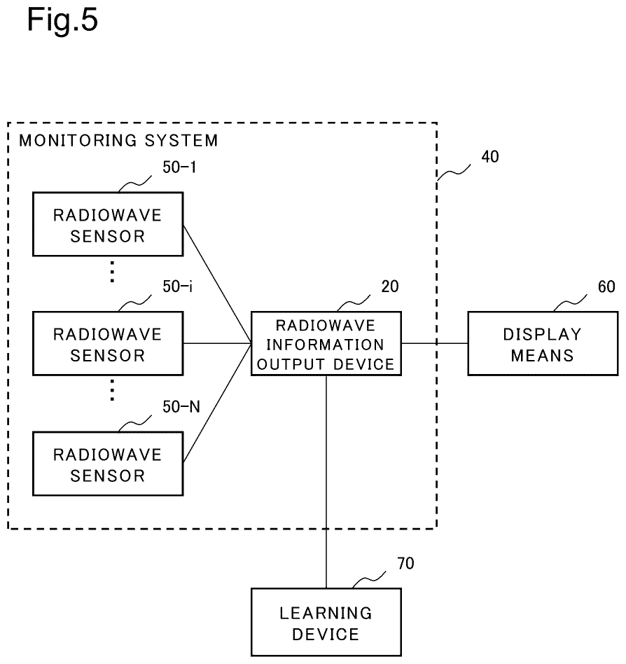

The collation unit 22 may use machine learning for collation in such a way as to determine whether the reception signal waveform matches with the collation signal waveform. FIG. 5 illustrates a system configuration example when machine learning is used. In the example illustrated in FIG. 5, a learning device 70 is connected to the radiowave information output device 20 in a wired or wireless manner. FIG. 5 illustrate the learning device 70 and the radiowave information output device 20 as different devices, but the radiowave information output device 20 may include the function of the learning device 70. Further, the learning device 70 may be included in the monitoring system 40.

The learning device 70 generates a model, based on learning data. Further, the collation unit 22 of the radiowave information output device 20 executes collation in such a way as to determine whether the reception signal waveform matches with the collation signal waveform, by using the model being generated by the learning device 70.

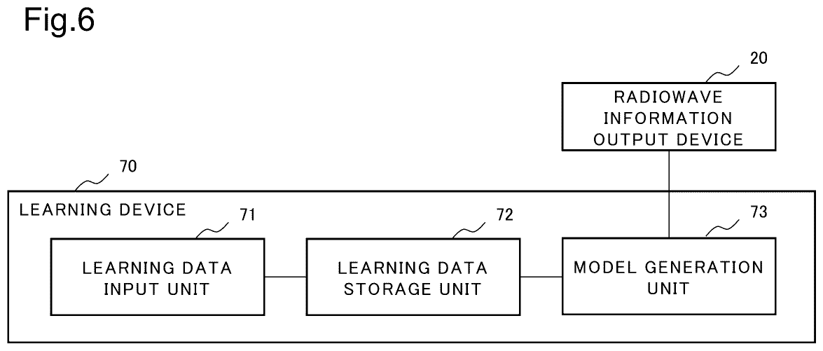

FIG. 6 illustrates a configuration example of the learning device 70 according to the present example embodiment. The learning device 70 is configured by a learning data input unit 71, a learning data storage unit 72, and a model generation unit 73.

The learning data input unit 71 receives and stores an input the learning data in the learning data storage unit 72. The learning data storage unit 72 stores the learning data. Further, the model generation unit 73 generates a model by machine learning, based on the learning data. Further, the model generation unit 73 transmits the model being generated to the radiowave information output device 20. the model generation unit 73 may generate a new model by newly performing machine learning whenever new learning data is registered in the learning data storage unit 72, or may generate a new model at a predetermined timing, such as at a regular interval.

The collation unit 22 of the radiowave information output device 20 can use machine learning for extraction of the radiowave feature information. In this case, for example, the learning data includes signal waveform data relating to radiowaves being output from various transmission sources.

Further, in this case, the model being generated by the model generation unit 73 of the learning device 70 is an extraction model for extracting the radiowave feature information from the signal waveform data. The model generation unit 73 generates an extraction model for extracting a signal waveform of each transmission source or at least extracting the radiowave feature information that enables distinction between collation signal waveform and other signal waveforms. Further, the collation unit 22 of the radiowave information output device 20 extracts the radiowave feature information from the reception waveform data, by using the extraction model being generated by the learning device 70. An input to the extraction model is the reception waveform data received by the reception unit 21. Further, an output from the extraction model is the radiowave feature information being extracted from the reception waveform data.

Further, machine learning can be used for collation between the radiowave feature information being extracted from the reception waveform data and the collation information. In this case, for example, the learning data includes the radiowave feature information being extracted from various transmission sources. Further, the learning data includes information indicating whether each piece of the radiowave feature information is the radiowave feature information relating to the collation signal waveform.

Further, in this case, the model being generated by the model generation unit 73 of the learning device 70 is a collation model for collating the radiowave feature information being input and the collation information with each other. More specifically, the collation model specifies whether there exists the collation information whose similarity degree with the radiowave feature information, which is included in the radiowave feature information, is equal to or greater than the predetermined value, based on the radiowave feature information being input. Further, the collation unit 22 of the radiowave information output device 20 uses the collation model, and specifies whether there exists the collation information whose similarity degree with the radiowave feature information, which is included in the radiowave feature information, is equal to or greater than the predetermined value, based on the radiowave feature information being extracted from the reception waveform data. An input to the collation model is the radiowave feature information in the reception waveform data. Further, an output of the collation model is information indicating whether there exists the collation signal waveform matching with the reception signal waveform.

In the method described above, the collation unit 22 collates the radiowave feature information being extracted from the reception waveform data and the collation information with each other. In this case, the collation information is the radiowave feature information relating to the collation signal waveform. However, the collation unit 22 may execute collation in such a way as to determine whether the reception signal waveform matches with the collation signal waveform, by collating the reception waveform data and the collation information with each other. In this case, the collation information is the signal waveform data relating to the collation signal waveform.

Further, in a case of this method, the collation unit 22 can also use machine learning. In this case, for example, the learning data includes the signal waveform data being output from various transmission sources. Further, the learning data includes information indicating whether each piece of the signal waveform data is the signal waveform data relating to the collation signal waveform.

Further, in this case, the model being generated by the model generation unit 73 of the learning device 70 is a specification model for specifying whether there exists the collation signal waveform matching with the signal waveform indicated by the signal waveform data, based on the signal waveform data being input. Further, the collation unit 22 of the radiowave information output device 20 uses the specification model being generated by the learning device 70, and specifies whether there exits the collation signal waveform matching with the reception signal waveform, based on the reception waveform data. An input to the specification model is the reception waveform data. Further, an output from the specification model is information indicating whether there exists the collation signal waveform matching with the reception signal waveform.

Next, specific examples of the image that the output unit 23 causes the display means 60 to display are described.

For example, the image may include a screen item indicating a transmission source, at a position of a transmission source of the unknown radiowave on a map. A radiowave for which the image includes the screen item indicating the transmission source is a radiowave for which the unknown radiowave information includes the information relating to the radiowave information. In other words, the image includes the screen item indicating the transmission source for the reception radiowave whose reception signal waveform does not match with any collation signal waveform.

Further, in a case of this display method, the unknown radiowave information includes information relating to an estimate result of the position of the transmission source. The method of estimating the position of the transmission source is described later. Further, the position of the transmission source is often estimated within a certain range, rather than as a pinpoint. Thus, the screen item indicating the transmission source may be displayed in a size indicating the range within which the transmission source is estimated to be present.

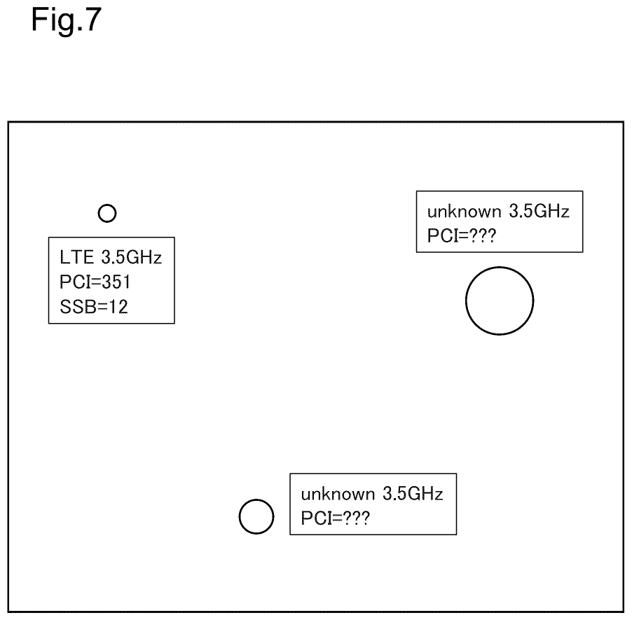

Further, for each radiowave, the image further includes at least part of the radiowave information. For example, the image may include the reception meta data in association with the screen item indicating the transmission source. FIG. 7 is a diagram illustrating an example of the display image. In the example of FIG. 7, the circle represents the screen item indicating the transmission source. In this manner, in the image, the screen item indicating the transmission source is arranged at the position of the transmission source on the map. Further, in the example of FIG. 7, the size of the screen item represents a range within which the transmission source is estimated to be present. Further, the image includes a type and a use frequency band of a radiowave, a PCI, and the like in association with the screen item indicating the transmission source.

Further, the output unit 23 may output the unknown radiowave information to an output destination other than the display means 60. For example, the unknown radiowave information may be data including the information relating to the radiowave information relating to the unknown radiowave. Further, the unknown radiowave information may include the information relating to the position of the transmission source of the unknown radiowave.

For example, the output unit 23 may output the unknown radiowave information to an alert management device managing an alert device for broadcasting an alert. For example, the alert device broadcasts an alert through specific wireless communication or disaster prevention wireless communication.

For each alert device, the storage unit stores identification information relating to the alert device, information relating to a position of the alert device, and information relating to a notification destination of the alert management device managing the alert device. The notification destination is an output destination of the unknown radiowave information being output from the output unit 23 to the alert management device. From the alert management device, the output unit 23 refers to the information relating to the position of the alert device, and specifies the alert device that is present within a predetermined distance from the transmission source of the unknown radiowave. Further, the output unit 23 specifies the alert management device managing the alert device that is present within the predetermined distance from the transmission source of the unknown radiowave. Further, the output unit 23 outputs the unknown radiowave information to the notification destination of the alert management device being specified. The unknown radiowave information in this case includes the identification information relating to the alert device that is present within the predetermined distance from the transmission source of the unknown radiowave.

In this manner, the alert management device that receives the unknown radiowave information can instruct the alert device, which is present near the transmission source of the unknown radiowave, to broadcast an alert. With this, by using the alert device that is present near the transmission source of the unknown radiowave, an alert can be issued to the transmission source of the unknown radiowave.

Further, for example, the output unit 23 may output the unknown radiowave information to a predetermined the notification destination such as a communication provider, and thus notify the communication provider or the like of presence of the unknown radiowave.

For example, for each communication provider, the storage unit stores information relating to the notification destination and information relating to a frequency band used in services provided by the communication provider, in advance. The notification destination is an output destination of the unknown radiowave information being output from the output unit 23 to the communication provider. The output unit 23 refers to the information relating to the frequency band used in the services provided by the communication provider, and specifies the communication provider whose frequency band used in the services being provided includes a frequency used in the unknown radiowave. Further, the output unit 23 outputs the unknown radiowave information to a notification destination of the specified communication provider. In this case, the unknown radiowave whose information is included in the unknown radiowave information is the unknown radiowave using the frequency included in the frequency band used in the services provided by the communication provider. Further, the unknown radiowave information includes at least part of the radiowave information relating to the unknown radiowave. For example, the unknown radiowave information includes information relating to the frequency used in the unknown radiowave, information relating to the position of the transmission source of the unknown radiowave, and the like.

In this manner, the communication provider can be provided with the information relating to the unknown radiowave that possibly acts as an interference wave against the services provided by the communication provider. Further, the communication provider can grasp possibility that radiowave interference occurs due to the unknown radiowave, and can take a measure.

Further, for example, the output unit 23 may notify the notification destination of presence of the unknown radiowave, by outputting the unknown radiowave information to the notification destination associated with the position of the transmission source of the unknown radiowave.

For example, the storage unit stores a correlation between notification destination information and area information, in advance. The output unit 23 refers to the correlation between the notification destination information and the area information, and specifies the notification destination belonging to the area including the position of the transmission source of the unknown radiowave. Further, the output unit 23 outputs the unknown radiowave information to the notification destination being specified. In this case, the unknown radiowave whose information is included in the unknown radiowave information is the unknown radiowave from the transmission source at the position included in the area associated with the notification destination. Further, the unknown radiowave information includes at least part of the radiowave information relating to the unknown radiowave. For example, the unknown radiowave information includes the information relating to the frequency used in the unknown radiowave, the information relating to the position of the transmission source of the unknown radiowave, and the like.

In this manner, the information relating to the unknown radiowave present within the area associated with the notification destination can be provided to the notification destination. Further, the notification destination can grasp possibility that radiowave interference occurs due to the unknown radiowave, and can take a measure. For example, an airport administrator or the like can be notified of presence of an unknown radiowave in an airport.

Next, the method of estimating the position of the transmission source of the unknown radiowave is described. As the method of estimating the position of the transmission source, a freely selected method may be used. For example, for estimation of the position of the transmission source, a radiowave transmission position estimation method such as an AOA method, a POA method, and a TDOA method may be used. Further, when the radiowave information received by the reception unit 21 includes position information relating to the transmission source, which is acquired by the transmission source by using the GNSS, the position information may be used.

One example of the method of estimating the position of the transmission source is described. In this example, the radiowave information received by the reception unit 21 includes a frequency of a reception signal, a modulation method, and position specification information. Further, the position specification information includes the direction information indicating the arrival direction of the radiowave.

First, the estimation unit 24 groups the radiowave sensor 50-1 to the radiowave sensor 50-N that are sensors receiving a radiowave from the same transmission source. A group being generated through grouping is a group of the radiowave sensors that are estimated to receive the same radiowave. One radiowave sensor can receive one or two or more radiowaves, and hence may possibly belong to a plurality of groups. The estimation unit 24 assumes that one radiowave sensor and another radiowave sensor, which satisfies both of the following conditions, are sensors receiving a radiowave from the same transmission source. The first condition is satisfied when frequencies and modulation methods of the reception radiowaves are the same. Further, the second condition is satisfied when a distance between the radiowave sensors falls within a predetermined range. The storage unit stores information relating to a position of each of the radiowave sensors 50-i.

Next, for each group, the estimation unit 24 estimates, as the position of the transmission source, an intersection of linear lines extended from the radiowave sensors in the arrival directions of the radiowave. For example, when the intersection is not determined uniquely, the estimation unit 24 estimates a region including two or more intersections, as the position of the transmission source. For example, the estimation unit 24 may assume that a minimum circle including the two or more intersections is a region being estimated as the position of the transmission source. Further, when the number of radiowave sensors included in a group is one, the estimation unit 24 may not estimate the position of the transmission source, or may estimate the position of the transmission source by a freely selected method. For example, the estimation unit 24 may assume that a region including a linear line having a predetermined length, which is extended from the position of the radiowave sensor in the arrival direction of the radiowave, is a region being estimated as the position of the transmission source.

Further, for estimation of the position of the transmission source, the estimation unit 24 may use information relating to the likelihood of the arrival direction of the radiowave. For example, when the arrival direction of the radiowave is estimated, the radiowave sensor 50-i further calculates the likelihood of the arrival direction. For example, the likelihood may be a value that is increased as a reception signal level is higher. In this case, the radiowave information being transmitted from the radiowave sensor 50-i to the radiowave information output device 20 includes the position specification information including the direction information and the information relating to the likelihood. Further, when a plurality of radiowave sensors belong to a group, and a plurality of intersections are present, the estimation unit 24 may estimate the position of the transmission source without using the direction information relating to the reception radiowave, the direction information having the likelihood lower than a predetermined standard.

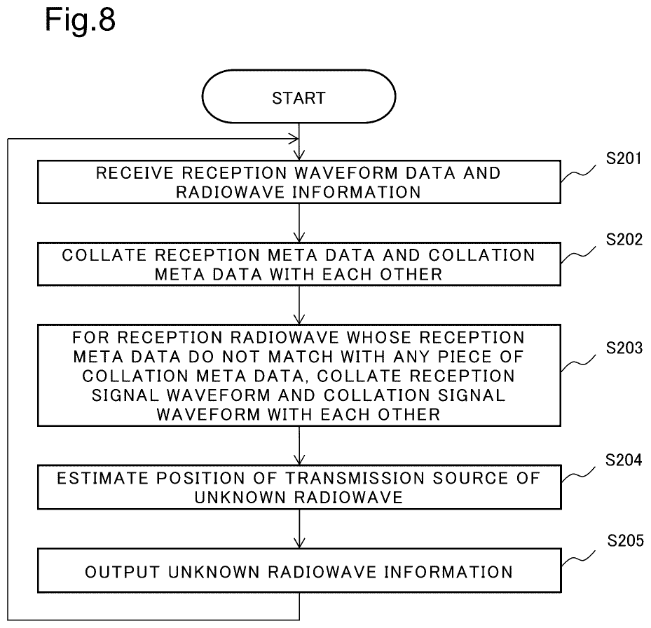

Next, an example of an operation flow of the radiowave information output device 20 according to the present example embodiment is described. FIG. 8 illustrates an example of the operation flow of the radiowave information output device 20 according to the present example embodiment.

The reception unit 21 receives the reception waveform data and the radiowave information from the radiowave sensor 50-i (step S201). In the present example embodiment, the reception waveform data and the radiowave information are transmitted at a predetermined interval from the radiowave sensor 50-i.

The collation unit 22 collates the reception meta data and the collation meta data with each other (step S202). Further, the collation unit 22 collates the reception signal waveform and the collation signal waveform with each other for the reception radiowave whose reception meta data does not match with any piece of the collation meta data (step S203). In the present example embodiment, collation is executed at a predetermined interval.

The estimation unit 24 estimates the position of the transmission source that transmits the reception radiowave whose reception signal waveform does not match with any collation signal waveform (the unknown radiowave) (step S204). When the information relating to the position of the transmission source is not included in the unknown radiowave information, the estimation unit 24 is not required to estimate the position of the transmission source.

Further, the output unit 23 outputs the unknown radiowave information (step S205). In the present example embodiment, the output unit 23 outputs the unknown radiowave information at a predetermined interval. The output unit 23 may output the unknown radiowave information at a freely selected timing instead of at a predetermined interval. For example, the output unit 23 may output the unknown radiowave information only when the unknown radiowave is present. Further, for example, when the unknown radiowave is not present, the output unit 23 may output the unknown radiowave information indicating that the unknown radiowave is not present. Further, the output unit 23 may output the unknown radiowave information when a device being an output destination of the unknown radiowave information issues a request.

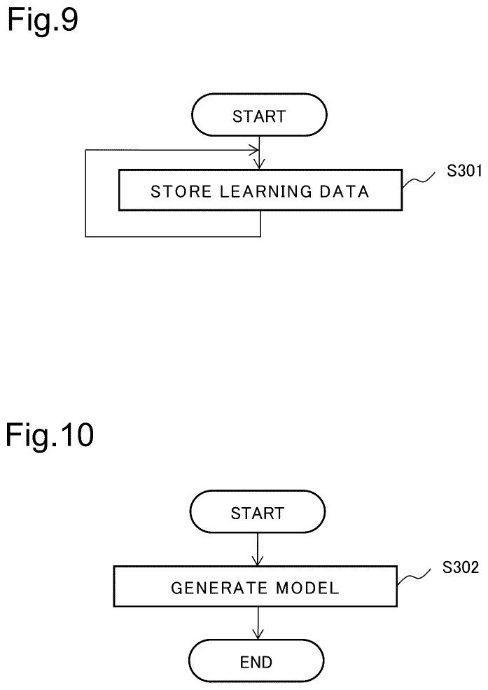

Next, FIG. 9 and FIG. 10 illustrate an operation example of the learning device 70 when machine learning is used for collation between the reception signal waveform and the collation signal waveform.

The radiowave information output device 20 executes step S203 in FIG. 8, by using the model received from the learning device 70. The model is at least one of the extraction model, the collation model, and the specification model that are described above.

The learning data input unit 71 of the learning device 70 receives and stores the learning data in the learning data storage unit 72 (step S301 in FIG. 9). Further, the model generation unit 73 generates the model at the predetermined timing, based on the learning data being stored in the learning data storage unit 72. For example, the predetermined timing is a timing at which new learning data is received or a timing at a predetermined interval. Further, the model generation unit 73 transmits the model being generated to the radiowave information output device 20 (step S302 in FIG. 10).

As described above, in the second example embodiment according to the present invention, the radiowave information output device 20 includes the reception unit 21, the collation unit 22, and the output unit 23. The reception unit 21 receives the reception waveform data and the radiowave information for the reception radiowave. The reception radiowave is a radiowave received by the radiowave sensor. The reception waveform data is data indicating the signal waveform of the reception radiowave. The radiowave information includes the identification information relating to the transmission source of the radiowave. The collation unit 22 executes collation in such a way as to determine whether the reception meta data matches with the collation meta data. The reception meta data is information included in the received radiowave information and the identification information relating to the transmission source of the radiowave. The collation meta data is the identification information relating to the transmission source of the known radiowave. Further, the collation unit 22 executes collation for the reception radiowave whose reception meta data does not match with any piece of the collation meta data in such a way as to determine whether the reception signal waveform matches with the collation signal waveform. The reception signal waveform is a signal waveform being indicated by the reception waveform data. The collation signal waveform is a signal waveform of the known radiowave. The output unit 23 outputs the unknown radiowave information. The unknown radiowave information is information relating to the unknown radiowave. The unknown radiowave is the reception radiowave whose reception signal waveform does not match with any collation signal waveform.

In this manner, the radiowave information output device 20 outputs the information relating to the unknown radiowave. The radiowave information output device 20 outputs the information relating to the unknown radiowave, and thus an investigator can refer to the information being output, can determine possibility of occurrence of radiowave interference more easily, and can take a measure against radiowave interference. As a result, time and labor for investigating radiowave interference and specifying an interference source can be reduced. Thus, it is possible to output information for reducing time and labor for investigating radiowave interference and specifying an interference source.

Further, in the present example embodiment, the output unit 23 prevents an output of the known radiowave information being the information relating to the radiowave information relating to the known radiowave. The known radiowave is the reception radiowave whose reception meta data matches with any piece of the collation meta data or the reception radiowave whose reception signal waveform matches with any collation signal waveform. In this case, an information amount from the radiowave information output device 20 to an output destination can be reduced, and a communication load can be reduced. Further, it becomes easy for a user to select and prioritize information.

Further, in the present example embodiment, the output unit 23 may output the known radiowave information being the information relating to the radiowave information relating to the known radiowave, distinctively from the unknown radiowave information. The known radiowave is the reception radiowave whose reception meta data matches with any piece of the collation meta data or the reception radiowave whose reception signal waveform matches with any collation signal waveform. In this case, the known radiowave information is distinguished from the unknown radiowave information, and hence it becomes easier for a user to select and prioritize information.

Further, in the present example embodiment, the output unit 23 specifies the communication provider whose frequency band used in the services provided the communication provider includes the frequency used in the unknown radiowave, and outputs the unknown radiowave information to the notification destination of the specified communication provider. Further, the unknown radiowave information includes the information relating to the unknown radiowave that uses the frequency included in the frequency band used in the services provided by the communication provider being specified. With this, the communication provider can be provided with the information relating to the transmission source of the unknown radiowave that possibly acts as an interference wave against the services provided by the communication provider. Further, the communication provider can grasp possibility that radiowave interference occurs due to the unknown radiowave, and can take a measure.

Further, in the present example embodiment, the radiowave information output device 20 further includes the estimation unit 24 that estimates the position of the transmission source of the unknown radiowave. The radiowave information includes the position specification information being information to be used for estimating the position of the transmission source. The estimation unit 24 estimates the position of the transmission source of the unknown radiowave, based on the position specification information. With this, the radiowave information output device 20 can output the information relating to the position of the transmission source of the unknown radiowave. Further, an investigator can refer to the information being output, can grasp possibility that radiowave interference occurs, and can take a measure according to the position of the transmission source.

Further, in the present example embodiment, the output unit 23 outputs the unknown radiowave information to the display means for displaying an image. The unknown radiowave information is the image information for causing the display means to display an image. The image includes the screen item indicating the transmission source, at the position of the transmission source of the unknown radiowave on the map. With this, an investigator who confirms the display can easily grasp the position of the transmission source of the unknown radiowave, and hence time and labor for investigating radiowave interference or specifying an interference source can be reduced.

Further, in the present example embodiment, the output unit 23 specifies the alert device that is present within the predetermined distance from the transmission source of the unknown radiowave, and outputs the unknown radiowave information to the notification destination of the alert management device managing the alert device being specified. The unknown radiowave information includes the identification information relating to the alert device that is present within the predetermined distance from the transmission source of the unknown radiowave. The alert device broadcasts an alert. With this, by using the alert device that is present near the transmission source of the unknown radiowave, an alert can be issued to the transmission source of the unknown radiowave.

Further, in the present example embodiment, the collation unit 22 may execute collation in such a way as to determine whether the reception signal waveform matches with the collation signal waveform, based on the radiowave feature information indicating the feature of the signal waveform of the radiowave.

Further, in the present example embodiment, the collation unit 22 may execute collation in such a way as to determine the reception signal waveform matches with the collation signal waveform, by extracting the radiowave feature information from the reception waveform data and collating the radiowave feature information being extracted and the collation information being the radiowave feature information relating to the collation signal waveform with each other.

Further, in the present example embodiment, the collation unit 22 may extract the radiowave feature information from the reception waveform data, based on the extraction model for extracting the radiowave feature information from the signal waveform data relating to the radiowave.

Further, in the present example embodiment, the collation unit 22 may executes collation between the radiowave feature information being extracted and the collation information, based on the collation model for collating the radiowave feature information and the collation information with each other.

Further, in the present example embodiment, the collation unit 22 may execute collation in such a way as to determine whether the reception signal waveform matches with the collation signal waveform, based on the specification model for specifying, from the signal waveform data relating to the radiowave, whether the signal waveform being indicated by the signal waveform data matches with the collation signal waveform. Collation between the reception signal waveform and the collation signal waveform can be achieved by those methods.

### [Hardware Configuration Example]

Description is made on a configuration example of hardware resources for achieving the above-mentioned radiowave information output device (10, 20) according to each of the exemplary embodiments of the present invention by using one information processing device (computer). The radiowave information output device may be achieved physically or functionally by using at least two information processing devices. Further, the radiowave information output device may be achieved as a dedicated device. Further, only some of the functions of the radiowave information output device may be achieved by using the information processing device.

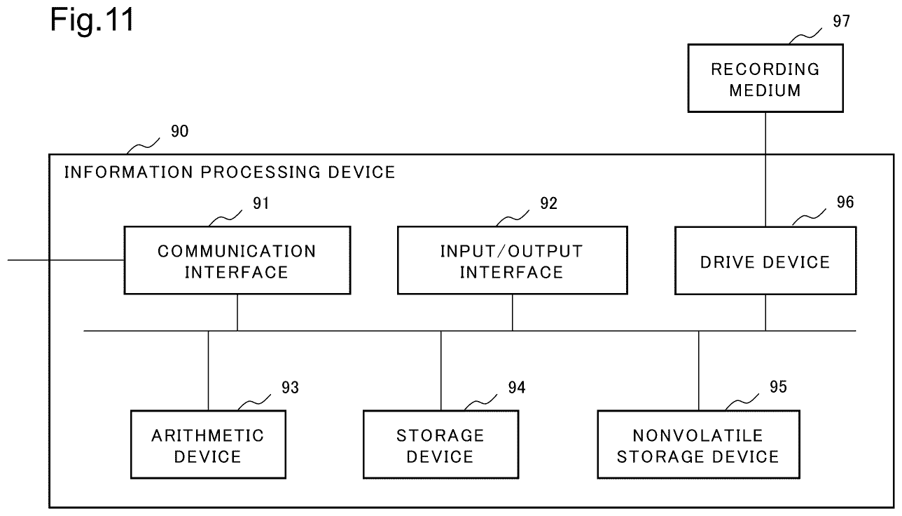

FIG. 11 is a diagram schematically illustrating a hardware configuration example of an information processing device capable of achieving the radiowave information output device according to each of the exemplary embodiments of the present invention. An information processing device 90 includes a communication interface 91, an input/output interface 92, an arithmetic device 93, a storage device 94, a nonvolatile storage device 95, and a drive device 96.

For example, the reception unit 11 and the output unit 13 in FIG. 1 can be achieved by the communication interface 91 and the arithmetic device, and the collation unit 12 can be achieved by the arithmetic device 93.

The communication interface 91 is a communication means for causing the radiowave information output device of each of the exemplary embodiments to communicate with an external device in a wired and/or wireless manner. When the radiowave information output device is achieved by using at least two information processing devices, those devices may be connected to each other in a communicable manner via the communication interface 91.

The input/output interface 92 is a human machine interface including a keyboard being an example of an input device, a display being an output device, and the like.

The arithmetic device 93 is achieved by an arithmetic processing device such as a general central processing unit (CPU) and a microprocessor and a plurality of electric circuits. For example, the arithmetic device 93 is capable of reading various programs stored in the nonvolatile storage device 95 into the storage device 94 and executing processing according to the read program.

The storage device 94 is a memory device such as a random access memory (RAM) to which the arithmetic device 93 can refer, and stores a program, various data, and the like. The storage device 94 may be a volatile memory device.

For example, the nonvolatile storage device 95 is a nonvolatile storage device such as a read only memory (ROM) and a flash memory, and is capable of storing various programs, data, and the like.

The drive device 96 is a device that execute processing of reading and writing data with respect to a recording medium 97, which is described later, for example.

For example, the recording medium 97 is a freely selected recording medium capable of recording data, such as an optical disk, a magneto-optical disk, and a semi-conductor flash memory.

For example, each of the exemplary embodiments of the present invention may be achieved by configuring the radiowave information output device by the information processing device 90 illustrated in FIG. 11 and supplying a program for achieving the functions described in each of the above-mentioned exemplary embodiments to the radiowave information output device.

In this case, the program supplied to the radiowave information output device is executed by the arithmetic device 93, and thus the exemplary embodiments can be achieved. Further, some of the functions instead of all the functions of the radiowave information output device may be configured by the information processing device 90.

Moreover, the above-mentioned program is stored in the recording medium 97, and the radiowave information output device may be configured in such a way that the above-mentioned program is stored as appropriate in the nonvolatile storage device 95 at the time of shipping or operating the radiowave information output device. In this case, as the method of supplying the above-mentioned program, there may be adopted a method of installing the program in the radiowave information output device by using an appropriate jig at the time of manufacturing before shipping or at the time of operation. Further, as the method of supplying the above-mentioned program, there may be adopted a general procedure such as a method of downloading the program from the outside via a communication line such as the Internet.

The whole or a part of the example embodiments described above can be described as, but not limited to, the following supplementary notes.

### (Supplementary Note 1)

A radiowave information output device comprising:
a reception means for receiving reception waveform data and radiowave information for a reception radiowave being a radiowave received by a radiowave sensor, the reception waveform data being data indicating a signal waveform of the reception radiowave;
a collation means for executing collation in such a way as to determine whether reception meta data being information included in the received radiowave information and identification information relating to a transmission source of a radiowave match with collation meta data being identification information relating to a transmission source of a known radiowave, and executing collation for the reception radiowave whose reception meta data do not match with any piece of the collation meta data in such a way as to determine whether a reception signal waveform being a signal waveform being indicated by the reception waveform data matches with a collation signal waveform being a signal waveform of the known radiowave; and
an output means for outputting unknown radiowave information for an unknown radiowave being the reception radiowave whose reception signal waveform does not match with any of the collation signal waveforms, unknown radiowave information being information relating to the unknown radiowave.

### (Supplementary Note 2)

The radiowave information output device according to Supplementary note 1, wherein
the output means prevents an output of known radiowave information being information relating to the radiowave information relating to the known radiowave, and
the known radiowave is the reception radiowave whose reception meta data match with any piece of the collation meta data, or is the reception radiowave whose reception signal waveform matches with any of the collation signal waveforms.

### (Supplementary Note 3)

The radiowave information output device according to Supplementary note 1, wherein
the output means outputs known radiowave information being information relating to the radiowave information relating to the known radiowave, distinctively from the unknown radiowave information, and
the known radiowave is the reception radiowave whose reception meta data match with any piece of the collation meta data, or is the reception radiowave whose reception signal waveform matches with any of the collation signal waveforms.

### (Supplementary Note 4)

The radiowave information output device according to any one of Supplementary notes 1 to 3, wherein
the output means specifies a communication provider whose frequency band used in a service provided by the communication provider includes a frequency used in the unknown radiowave, and outputs the unknown radiowave information to a notification destination of the specified communication provider, and
the unknown radiowave information includes information relating to the unknown radiowave using a frequency being included in a frequency band used in a service provided by the specified communication provider.

### (Supplementary Note 5)

The radiowave information output device according to any one of Supplementary notes 1 to 3, further comprising:
an estimation means for estimating a position of a transmission source of the unknown radiowave, wherein
the radiowave information includes position specification information being information to be used for estimating a position of a transmission source, and
the estimation means estimates a position of the transmission source of the unknown radiowave, based on the position specification information.

### (Supplementary Note 6)

The radiowave information output device according to Supplementary note 5, wherein
the output means outputs the unknown radiowave information to a display means for displaying an image,
the unknown radiowave information is image information for causing the display means to display the image, and
the image includes a screen item indicating a transmission source, at a position of the transmission source of the unknown radiowave on a map.

### (Supplementary Note 7)

The radiowave information output device according to Supplementary note 5, wherein
the output means specifies an alert device being present within a predetermined distance from a transmission source of the unknown radiowave, and outputs the unknown radiowave information to a notification destination of an alert management device managing the specified alert device,
the unknown radiowave information includes identification information relating to the alert device being present within a predetermined distance from the transmission source of the unknown radiowave, and
the alert device broadcasts an alert.

### (Supplementary Note 8)

The radiowave information output device according to any one of Supplementary notes 1 to 7, wherein
the collation means executes collation in such a way as to determine whether the reception signal waveform matches with the collation signal waveform, based on radiowave feature information indicating a feature of a signal waveform of a radiowave.

### (Supplementary Note 9)

The radiowave information output device according to Supplementary note 8, wherein
the collation means executes collation in such a way as to determine whether the reception signal waveform matches with the collation signal waveform, by extracting the radiowave feature information from the reception waveform data and collating the extracted radiowave feature information and collation information being the radiowave feature information relating to the collation signal waveform with each other.

### (Supplementary Note 10)

The radiowave information output device according to Supplementary note 9, wherein
the collation means extracts the radiowave feature information from the reception waveform data, based on an extraction model for extracting the radiowave feature information from signal waveform data relating to a radiowave.

### (Supplementary Note 11)

The radiowave information output device according to Supplementary note 9 or 10, wherein
the collation means collates the extracted radiowave feature information and the collation information with each other, based on a collation model for collating the radiowave feature information and the collation information with each other.

### (Supplementary Note 12)

The radiowave information output device according to any one of Supplementary notes 1 to 11, wherein
the collation means executes collation in such a way as to determine whether the reception signal waveform matches with the collation signal waveform, based on a specification model for specifying, from signal waveform data relating to a radiowave, whether a signal waveform being indicated by the signal waveform data matches with the collation signal waveform.

### (Supplementary Note 13)

A radiowave information output method comprising:
receiving reception waveform data and radiowave information for a reception radiowave being a radiowave received by a radiowave sensor, the reception waveform data being data indicating a signal waveform of the reception radiowave;
executing collation in such a way as to determine whether reception meta data being information included in the received radiowave information and identification information relating to a transmission source of the radiowave match with collation meta data being identification information relating to a transmission source of a known radiowave, and executing collation for the reception radiowave whose reception meta data do not match with any piece of the collation meta data in such a way as to determine whether a reception signal waveform being a signal waveform being indicated by the reception waveform data matches with a collation signal waveform being a signal waveform of the known radiowave; and
outputting unknown radiowave information for an unknown radiowave being the reception radiowave whose reception signal waveform does not match with any of the collation signal waveforms, unknown radiowave information being information relating to the unknown radiowave.

### (Supplementary Note 14)

The radiowave information output method according to Supplementary note 13, wherein
an output of known radiowave information being information relating to the radiowave information relating to the known radiowave is prevented, and
the known radiowave is the reception radiowave whose reception meta data match with any piece of the collation meta data, or is the reception radiowave whose reception signal waveform matches with any of the collation signal waveforms.

### (Supplementary Note 15)

The radiowave information output method according to Supplementary note 13, wherein
known radiowave information being information relating to the radiowave information relating to the known radiowave is output distinctively from the unknown radiowave information, and
the known radiowave is the reception radiowave whose reception meta data match with any piece of the collation meta data, or is the reception radiowave whose reception signal waveform matches with any of the collation signal waveforms.

### (Supplementary Note 16)

The radiowave information output method according to any one of Supplementary notes 13 to 15, wherein
a communication provider whose frequency band used in a service provided by the communication provider includes a frequency used in the unknown radiowave is specified, and the unknown radiowave information is output to a notification destination of the specified communication provider, and
the unknown radiowave information includes information relating to the unknown radiowave using a frequency being included in a frequency band used in a service provided by the specified communication provider.

### (Supplementary Note 17)

The radiowave information output method according to any one of Supplementary notes 13 to 15, further comprising:
an estimation means for estimating a position of a transmission source of the unknown radiowave, wherein
the radiowave information includes position specification information being information to be used for estimating a position of a transmission source, and
a position of a transmission source of the unknown radiowave is estimated, based on the position specification information.

### (Supplementary Note 18)

The radiowave information output method according to Supplementary note 17, wherein
the unknown radiowave information is output to a display means for displaying an image,
the unknown radiowave information is image information for causing the display means to display the image, and
the image includes a screen item indicating a transmission source, at a position of a transmission source of the unknown radiowave on a map.

### (Supplementary Note 19)

The radiowave information output method according to Supplementary note 17, wherein
an alert device being present within a predetermined distance from a transmission source of the unknown radiowave is specified, and the unknown radiowave information is output to a notification destination of an alert management device managing the specified alert device,
the unknown radiowave information includes identification information relating to the alert device being present within a predetermined distance from the transmission source of the unknown radiowave, and
the alert device broadcasts an alert.

### (Supplementary Note 20)

The radiowave information output method according to any one of Supplementary notes 13 to 19, wherein
collation is executed in such a way as to determine whether the reception signal waveform matches with the collation signal waveform, based on radiowave feature information indicating a feature of a signal waveform of a radiowave.

### (Supplementary Note 21)

The radiowave information output method according to Supplementary note 20, wherein
collation is executed in such a way as to determine whether the reception signal waveform matches with the collation signal waveform, by extracting the radiowave feature information from the reception waveform data and collating the extracted radiowave feature information and collation information being the radiowave feature information relating to the collation signal waveform with each other.

### (Supplementary Note 22)

The radiowave information output method according to Supplementary note 21, wherein
the radiowave feature information is extracted from the reception waveform data, based on an extraction model for extracting the radiowave feature information from signal waveform data relating to a radiowave.

### (Supplementary Note 23)

The radiowave information output method according to Supplementary note 21 or 22, wherein
the extracted radiowave feature information and the collation information are collated with each other, based on a collation model for collating the radiowave feature information and the collation information with each other.

### (Supplementary Note 24)

The radiowave information output method according to any one of Supplementary notes 13 to 23, wherein
collation is executed in such a way as to determine whether the reception signal waveform matches with the collation signal waveform, based on a specification model for specifying, from signal waveform data relating to a radiowave, whether a signal waveform being indicated by the signal waveform data matches with the collation signal waveform.

### (Supplementary Note 25)

A computer-readable recording medium recording a radiowave information output program causing a computer to achieve:
a reception function of receiving reception waveform data and radiowave information for a reception radiowave being a radiowave received by a radiowave sensor, the reception waveform data being data indicating a signal waveform of the reception radiowave;
a collation function of executing collation in such a way as to determine whether reception meta data being information included in the received radiowave information and identification information relating to a transmission source of a radiowave match with collation meta data being identification information relating to a transmission source of a known radiowave, and executing collation for the reception radiowave whose reception meta data do not match with any piece of the collation meta data in such a way as to determine whether a reception signal waveform being a signal waveform being indicated by the reception waveform data matches with a collation signal waveform being a signal waveform of the known radiowave; and
an output function of outputting, for an unknown radiowave being the reception radiowave whose reception signal waveform does not match with any of the collation signal waveforms, unknown radiowave information being information relating to the unknown radiowave.

### (Supplementary Note 26)

The computer-readable recording medium recording the radiowave information output program according to Supplementary note 25, wherein
the output function prevents an output of known radiowave information being information relating to the radiowave information relating to the known radiowave, and
the known radiowave is the reception radiowave whose reception meta data match with any piece of the collation meta data, or is the reception radiowave whose reception signal waveform matches with any of the collation signal waveforms.

### (Supplementary Note 27)

The computer-readable recording medium recording the radiowave information output program according to Supplementary note 25, wherein
the output function outputs known radiowave information being information relating to the radiowave information relating to the known radiowave, distinctively from the unknown radiowave information, and
the known radiowave is the reception radiowave whose reception meta data match with any piece of the collation meta data, or is the reception radiowave whose reception signal waveform matches with any of the collation signal waveforms.

### (Supplementary Note 28)

The computer-readable recording medium recording the radiowave information output program according to any one of Supplementary notes 25 to 27, wherein
the output function specifies a communication provider whose frequency band used in a service provided by the communication provider includes a frequency used in the unknown radiowave, and outputs the unknown radiowave information to a notification destination of the specified communication provider, and
the unknown radiowave information includes information relating to the unknown radiowave using a frequency being included in a frequency band used in a service provided by the specified communication provider.

### (Supplementary Note 29)

The computer-readable recording medium recording the radiowave information output program according to any one of Supplementary notes 25 to 27, the radiowave information output program further causing a computer to achieve
an estimation function of estimating a position of a transmission source of the unknown radiowave, wherein
the radiowave information includes position specification information being information to be used for estimating a position of a transmission source, and
the estimation function estimates a position of the transmission source of the unknown radiowave, based on the position specification information.

### (Supplementary Note 30)

The computer-readable recording medium recording the radiowave information output program according to Supplementary note 29, wherein
the output function outputs the unknown radiowave information to a display means for displaying an image,
the unknown radiowave information is image information for causing the display means to display the image, and
the image includes a screen item indicating a transmission source, at a position of a transmission source of the unknown radiowave on a map.

### (Supplementary Note 31)

The computer-readable recording medium recording the radiowave information output program according to Supplementary note 29, wherein
the output function specifies an alert device being present within a predetermined distance from a transmission source of the unknown radiowave, and outputs the unknown radiowave information to a notification destination of an alert management device managing the specified alert device,
the unknown radiowave information includes identification information relating to the alert device being present within a predetermined distance from the transmission source of the unknown radiowave, and
the alert device broadcasts an alert.

### (Supplementary Note 32)

The computer-readable recording medium recording the radiowave information output program according to any one of Supplementary notes 25 to 31, wherein
the collation function executes collation in such a way as to determine whether the reception signal waveform matches with the collation signal waveform, based on radiowave feature information indicating a feature of a signal waveform of a radiowave.

### (Supplementary Note 33)

The computer-readable recording medium recording the radiowave information output program according to Supplementary note 32, wherein
the collation function executes collation in such a way as to determine whether the reception signal waveform matches with the collation signal waveform, by extracting the radiowave feature information from the reception waveform data and collating the extracted radiowave feature information and collation information being the radiowave feature information relating to the collation signal waveform with each other.

### (Supplementary Note 34)

The computer-readable recording medium recording the radiowave information output program according to Supplementary note 33, wherein
the collation function extracts the radiowave feature information from the reception waveform data, based on an extraction model for extracting the radiowave feature information from signal waveform data relating to a radiowave.

### (Supplementary Note 35)

The computer-readable recording medium recording the radiowave information output program according to Supplementary note 33 or 34, wherein
the collation function collates the extracted radiowave feature information and the collation information with each other, based on a collation model for collating the radiowave feature information and the collation information with each other.

### (Supplementary Note 36)

The computer-readable recording medium recording the radiowave information output program according to any one of Supplementary notes 25 to 35, wherein
the collation function executes collation in such a way as to determine whether the reception signal waveform matches with the collation signal waveform, based on a specification model for specifying, from signal waveform data relating to a radiowave, whether a signal waveform being indicated by the signal waveform data matches with the collation signal waveform.

### (Supplementary Note 37)

A radiowave information output system comprising:
a reception means for receiving reception waveform data and radiowave information for a reception radiowave being a radiowave received by a radiowave sensor, the reception waveform data being data indicating a signal waveform of the reception radiowave;
a collation means for executing collation in such a way as to determine whether reception meta data being information included in the received radiowave information and identification information relating to a transmission source of a radiowave match with collation meta data being identification information relating to a transmission source of a known radiowave, and executing collation for the reception radiowave whose reception meta data do not match with any piece of the collation meta data in such a way as to determine whether a reception signal waveform being a signal waveform being indicated by the reception waveform data matches with a collation signal waveform being a signal waveform of the known radiowave; and
an output means for outputting unknown radiowave information for an unknown radiowave being the reception radiowave whose reception signal waveform does not match with any of the collation signal waveforms, unknown radiowave information being information relating to the unknown radiowave.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

### REFERENCE SIGNS LIST

10, 20 Radiowave information output device
11, 21 Reception unit
12, 22 Collation unit
13, 23 Output unit
24 Estimation unit
40 Monitoring system
50-i Radiowave sensor
60 Display means
70 Learning device
71 Learning data input unit
72 Learning data storage unit
73 Model generation unit
90 Information processing device
91 Communication interface
92 Input/output interface
93 Arithmetic device
94 Storage device
95 Nonvolatile storage device
96 Drive device
97 Recording medium

What is claimed is:

1. A radiowave information output device comprising one or more memories storing instructions and one or more processors configured to execute the instructions to:
receive reception waveform data and radiowave information for a reception radiowave being a radiowave received by a radiowave sensor, the reception waveform data being data indicating a signal waveform of the reception radiowave;
execute collation in such a way as to determine whether reception meta data being information included in the received radiowave information and identification information relating to a transmission source of a radiowave match with collation meta data being identification information relating to a transmission source of a known radiowave, and execute collation for the reception radiowave whose reception meta data do not match with any piece of the collation meta data in such a way as to determine whether a reception signal waveform being a signal waveform being indicated by the reception waveform data matches with a collation signal waveform being a signal waveform of the known radiowave; and
output unknown radiowave information for an unknown radiowave being the reception radiowave whose reception signal waveform does not match with any of the collation signal waveforms, unknown radiowave information being information relating to the unknown radiowave.

2. The radiowave information output device according to claim 1, wherein
an output of known radiowave information being information relating to the radiowave information relating to the known radiowave is prevented, and
the known radiowave is the reception radiowave whose reception meta data match with any piece of the collation meta data, or is the reception radiowave whose reception signal waveform matches with any of the collation signal waveforms.

3. The radiowave information output device according to claim 1, wherein
known radiowave information being information relating to the radiowave information relating to the known radiowave is output distinctively from the unknown radiowave information, and
the known radiowave is the reception radiowave whose reception meta data match with any piece of the collation meta data, or is the reception radiowave whose reception signal waveform matches with any of the collation signal waveforms.

4. The radiowave information output device according to claim 1, wherein
a communication provider whose frequency band used in a service provided by the communication provider includes a frequency used in the unknown radiowave is specified, and the unknown radiowave information is output to a notification destination of the specified communication provider, and
the unknown radiowave information includes information relating to the unknown radiowave using a frequency included in a frequency band used in a service provided by the specified communication provider.

5. The radiowave information output device according to claim 1, wherein
the processors are configured to execute the instructions to estimate a position of a transmission source of the unknown radiowave,
the radiowave information includes position specification information being information to be used for estimating a position of a transmission source, and
a position of the transmission source of the unknown radiowave is estimated, based on the position specification information.

6. The radiowave information output device according to claim 5, wherein
the unknown radiowave information is output to display means for displaying an image,
the unknown radiowave information is image information for causing the display means to display the image, and
the image includes a screen item indicating a transmission source, at a position of the transmission source of the unknown radiowave on a map.

7. The radiowave information output device according to claim 5, wherein
an alert device being present within a predetermined distance from a transmission source of the unknown radiowave is specified, and the unknown radiowave information is output to a notification destination of an alert management device managing the specified alert device,
the unknown radiowave information includes identification information relating to the alert device being present within a predetermined distance from the transmission source of the unknown radiowave, and
the alert device broadcasts an alert.

8. The radiowave information output device according to claim 1, wherein
collation is executed in such a way as to determine whether the reception signal waveform matches with the collation signal waveform, based on radiowave feature information indicating a feature of a signal waveform of a radiowave.

9. The radiowave information output device according to claim 8, wherein
collation is executed in such a way as to determine whether the reception signal waveform matches with the collation signal waveform, by extracting the radiowave feature information from the reception waveform data and collating the extracted radiowave feature information and collation information being the radiowave feature information relating to the collation signal waveform with each other.

10. The radiowave information output device according to claim 9, wherein
the radiowave feature information is extracted from the reception waveform data, based on an extraction model for extracting the radiowave feature information from signal waveform data relating to a radiowave.

11. The radiowave information output device according to claim 9, wherein
the extracted radiowave feature information and the collation information are collated with each other, based on a collation model for collating the radiowave feature information and the collation information with each other.

12. The radiowave information output device according to claim 1, wherein
collation is executed in such a way as to determine whether the reception signal waveform matches with the collation signal waveform, based on a specification model for specifying, from signal waveform data relating to a radiowave, whether a signal waveform being indicated by the signal waveform data matches with the collation signal waveform.

13. A radiowave information output method comprising:
receiving reception waveform data and radiowave information for a reception radiowave being a radiowave received by a radiowave sensor, the reception waveform data being data indicating a signal waveform of the reception radiowave;
executing collation in such a way as to determine whether reception meta data being information included in the received radiowave information and identification information relating to a transmission source of the radiowave match with collation meta data being identification information relating to a transmission source of a known radiowave, and executing collation for the reception radiowave whose reception meta data do not match with any piece of the collation meta data in such a way as to determine whether a reception signal waveform being a signal waveform being indicated by the reception waveform data matches with a collation signal waveform being a signal waveform of the known radiowave; and
outputting unknown radiowave information for an unknown radiowave being the reception radiowave whose reception signal waveform does not match with any of the collation signal waveforms, unknown radiowave information being information relating to the unknown radiowave.

14. The radiowave information output method according to claim 13, wherein
an output of known radiowave information being information relating to the radiowave information relating to the known radiowave is prevented, and
the known radiowave is the reception radiowave whose reception meta data match with any piece of the collation meta data, or is the reception radiowave whose reception signal waveform matches with any of the collation signal waveforms.

15. The radiowave information output method according to claim 13, wherein
known radiowave information being information relating to the radiowave information relating to the known radiowave is output distinctively from the unknown radiowave information, and
the known radiowave is the reception radiowave whose reception meta data match with any piece of the collation meta data, or is the reception radiowave whose reception signal waveform matches with any of the collation signal waveforms.

16. The radiowave information output method according to claim 13, wherein
a communication provider whose frequency band used in a service provided by the communication provider includes a frequency used in the unknown radiowave is specified, and the unknown radiowave information is output to a notification destination of the specified communication provider, and
the unknown radiowave information includes information relating to the unknown radiowave using a frequency being included in a frequency band used in a service provided by the specified communication provider.

17. The radiowave information output method according to claim 13, further comprising:
estimating a position of a transmission source of the unknown radiowave, wherein
the radiowave information includes position specification information being information to be used for estimating a position of a transmission source, and
a position of a transmission source of the unknown radiowave is estimated, based on the position specification information.

18. The radiowave information output method according to claim 17, wherein
the unknown radiowave information is output to display means for displaying an image,
the unknown radiowave information is image information for causing the display means to display the image, and
the image includes a screen item indicating a transmission source, at a position of a transmission source of the unknown radiowave on a map.

19. The radiowave information output method according to claim 17, wherein
an alert device being present within a predetermined distance from a transmission source of the unknown radiowave is specified, and the unknown radiowave information is output to a notification destination of an alert management device managing the specified alert device,
the unknown radiowave information includes identification information relating to the alert device being present within a predetermined distance from the transmission source of the unknown radiowave, and
the alert device broadcasts an alert.

20-24. (canceled)

25. A non-transitory computer-readable recording medium recording a radiowave information output program causing a computer to achieve:
a reception function of receiving reception waveform data and radiowave information for a reception radiowave being a radiowave received by a radiowave sensor, the reception waveform data being data indicating a signal waveform of the reception radiowave;
a collation function of executing collation in such a way as to determine whether reception meta data being information included in the received radiowave information and identification information relating to a transmission source of a radiowave match with collation meta data being identification information relating to a transmission source of a known radiowave, and executing collation for the reception radiowave whose reception meta data do not match with any piece of the collation meta data in such a way as to determine whether a reception signal waveform being a signal waveform being indicated by the reception waveform data matches with a collation signal waveform being a signal waveform of the known radiowave; and
an output function of outputting, for an unknown radiowave being the reception radiowave whose reception signal waveform does not match with any of the collation signal waveforms, unknown radiowave information being information relating to the unknown radiowave.

26-37. (canceled)
